(19) United States
(12) Patent Application Publication
(10) Pub. No.: US 2017/0020334 A1
(43) Pub. Date: Jan. 26, 2017

(54) MULTIPURPOSE ELECTRIC COOKING GRILL

(71) Applicant: Spectrum Brands, Inc., Middleton, WI (US)

(72) Inventors: Nicole Ann Sorenson, Verona, WI (US); Byron Seth Sawyer, Middleton, WI (US); Samantha L. Cherney, Madison, WI (US); Charles H. Wilfer, III, Fitchburg, WI (US)

(21) Appl. No.: 15/060,931

(22) Filed: Mar. 4, 2016

Related U.S. Application Data
(60) Provisional application No. 62/128,929, filed on Mar. 5, 2015.

(51) Int. Cl. A47J 37/07

(52) U.S. Cl. CPC A47J 37/0709; A47J 37/0786; A47J 2037/0795

(57) ABSTRACT

A multipurpose electric cooking grill includes one or more electrical heating elements for cooking food products. In one configuration the cooking grill is configured for indoor and outdoor use. In another configuration the cooking grill includes removable and interchangeable cooking plates, which allow a variety of food products to be cooked by the one or more electrical heating elements using a variety of cooking techniques.

### CROSS-REFERENCE TO RELATED APPLICATION(S)

This application claims priority to U.S. Ser. No. 62,128,929, filed on Mar. 5, 2015, and titled MULTIPURPOSE ELECTRIC COOKING GRILL, the disclosure of which is hereby incorporated by reference in its entirety.

### BACKGROUND

Outdoor cooking grills have traditionally used an open flame arrangement to cook food, and often utilize a fuel source such as coal, wood, or gas. Such an arrangement makes the use of such a grill unsafe for indoor use, in addition to the smoke and other fumes that may be emitted from such a grill during the cooking process. Alternatively, some outdoor grills use an electrically powered heating element to cook food. However, because food drippings often transfer to the heating element, causing smoke and other fumes, these grills are also unfit for indoor use.

Additionally, some grills use grilling grates to support food above the heat source, which limits the chef to grilling solid foodstuffs that are larger than the openings in the grate so that the food is not lost through the grate during the grilling process.

### SUMMARY

In general terms, this disclosure is directed to a multipurpose electric grill. In one possible configuration and by non-limiting example, the electric grill is configured for indoor and outdoor use. In another example embodiment, the electric grill is configured with removable plates to permit a variety of different cooking plates to be used for different cooking purposes. Various aspects are described in this disclosure, which include, but are not limited to the following aspects.

One aspect is a cooking grill including: a housing containing a first heating element and a second heating element. The cooking grill also includes a grill plate removably mountable on the housing. The grill plate has a top surface and a bottom surface, wherein the top surface is a cooking surface. The cooking grill also includes a grill cover that is configured to cover the removable grill plate. The grill cover further defines a cooking region between the grill plate top surface and the grill cover. The cooking grill also includes a removable stand that is configured to attach to the grill housing. The removable stand is configured to support the cooking grill on a ground surface at a table height. The cooking grill further includes a power supply within the housing. The power supply is configured to be electrically connected to an external power source and to supply power to the first and second heating elements.

Another aspect is a cooking grill including: a housing containing at a first heating element and a second heating element. The cooking grill also includes a first grill plate removably mountable to the housing. The first grill plate has a top surface and a bottom surface, wherein the top surface is a cooking surface and the bottom surface includes a receiving portion to receive the first heating element. The cooking grill also includes a second grill plate removably mountable to the housing. The second grill plate has a top surface and a bottom surface, wherein the top surface is a cooking surface and the bottom surface includes a receiving portion to receive the second heating element. The cooking grill further includes at least one drip tray removably mounted flush with the housing and under the first and second grill plates. The drip tray is configured to collect liquid from the first and second grill plate. The cooking grill also includes: a first thermostat in communication with the first grill plate and a second thermostat in communication with the second grill plate. The cooking grill also includes a controller in communication with the first and second heating elements and the first and second thermostats. The controller is configured to alter the behavior of the first and second heating elements based on measurements taken by the first and second thermostats. The cooking grill further includes a grill cover that is configured to cover the first and second grill plates. The cooking grill also includes a power supply contained in the housing and configured to be electrically connected to an external power source. The external power source is configured to power the first and second heating elements and the first and second thermostats.

### BRIEF DESCRIPTION OF THE DRAWINGS

FIG. 1 illustrates a perspective view of an electric indoor/outdoor cooking grill, according to one embodiment of the present disclosure.

FIG. 2 illustrates a front view of the electric indoor/outdoor cooking grill of FIG. 1.

FIG. 3 illustrates a perspective view of the cooking portion of the indoor/outdoor cooking grill of FIG. 1.

FIG. 4 illustrates a side view of the cooking portion of the indoor/outdoor cooking grill of FIG. 1 in the open position.

FIG. 5 illustrates a perspective view of the housing of the cooking portion of FIG. 3.

FIG. 6 illustrates a perspective view of the housing of the cooking portion of FIG.3 including a select number of internal components.

FIG. 7 illustrates a perspective view of the cooking portion of FIG.3 with the cover removed.

FIG. 8 illustrates a top view of the cooking portion of FIG.3 with the cover removed.

FIG. 9 illustrates a cross-section side view along line 9-9 in FIG. 8 of a grill plate.

FIG. 10 illustrates a perspective view of a cooking portion including two grill plates of an indoor/outdoor cooking grill, according to one embodiment of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

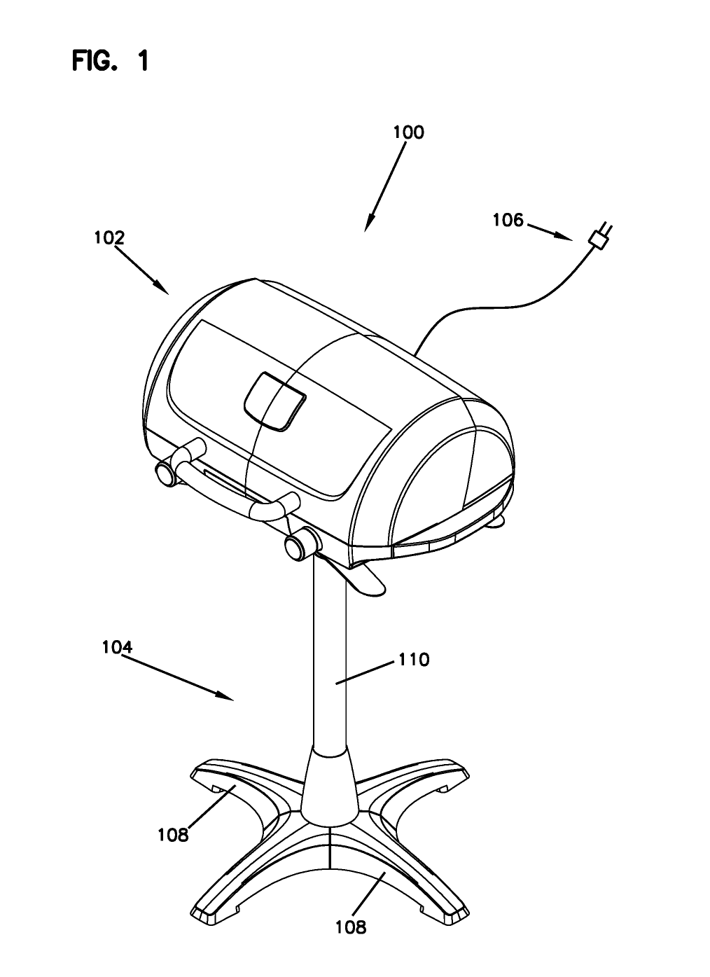

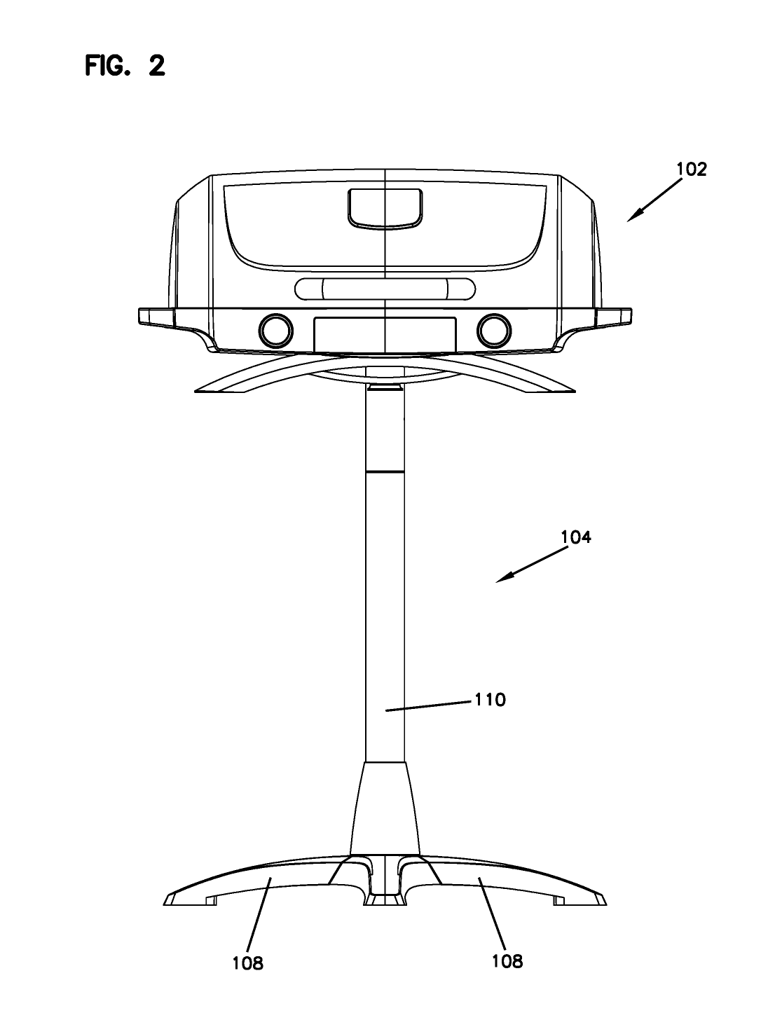

FIGS. 1 and 2 show a cooking grill 100. In this example, the cooking grill 100 includes a cooking portion 102 and a grill stand 104. The cooking grill 100 is an electric cooking grill that is configured to be connected to an external power source by way of a power cord 106. In some embodiments the cooking grill 100 is configured to be used in an indoor environment as well as an outdoor environment.

The cooking portion 102 is configured to generate and provide heat to a foodstuff for cooking. Additionally, the cooking portion is removable from the grill stand 104.

The grill stand 104 is removably attached to the cooking portion 102. The grill stand 104 includes a plurality of legs 108 and a main shaft 110. The grill stand 104 is configured to support the cooking portion 102 in a horizontal position at a height being generally that of table height. In some embodiments, the stand 104 is in a range from about 30 inches to about 40 inches tall. In other embodiments, the stand 104 is in a range from about 20 inches to about 30 inches tall. In other embodiments, the grill stand is about 30 inches tall. In still other embodiments, the grill stand has a telescoping shaft formed of multiple nested segments, which permit the grill stand height to be adjustable between a range of heights.

The legs 108 of the grill stand 104 are attached to the main shaft 110. In some embodiments, the legs 108 are removable. The removable legs are particularly helpful when the stand is packaged, such as during shipping, to allow the stand to take up less space in the packaging by disconnecting the legs 108 from the main shaft 110 In other embodiments, the legs 108 are extendable and maneuverable so that the user may adjust the length and position of the legs 108 for customized stability of the cooking portion 102. In other embodiments, the legs 108 are configured to be self-leveling on a surface so that the cooking portion is stabilized.

The main shaft 110 of the grill stand 104 is removably attached to the legs 108 and the cooking portion 102. In some embodiments, the main shaft 110 is hollow. In such an embodiment, the main shaft 110 is configured to house the power cord 106. In other embodiments, the main shaft 110 is a solid piece of material.

The main shaft 110 is removably connected to the cooking portion 102. In some embodiments, the main shaft 110 includes threads and is threaded into the cooking portion 102, or vice versa. In other embodiments, the main shaft 110 is bolted to the cooking portion 102. In still other embodiments, the main shaft 110 is connected to the cooking portion 102 using a quick-connect device.

In some embodiments the power cord 106 is a conventional three-wire insulated power cord where the third wire is ground. In some embodiments the power cord 106 is about 6 feet in length. The power cord 106 is configured to be connected to an AC or DC power source to obtain power for the cooking grill. An example of an AC power source is AC mains power, such as accessed through a power receptacle. An example of a DC power source is a battery. In some embodiments the power cord is routed into the housing of the cooking grill where it is electrically connected to power supply circuitry of the cooking portion 102 of the cooking grill. For example, the power supply circuitry can operate in some embodiments to convert the power from the power source into a form suitable for the cooking appliance. For example, the power supply can include an AC to DC converter, a fuse or surge protector, and other power supply electronics in some embodiments. In some embodiments, the power source, and the power supply operate to provide operating power to the cooking grill in a range from about 1000 Watts to about 2000 Watts. In some embodiments the cooking grill has an operating power in a range from about 1600 Watts to about 1700 Watts. In some embodiments, the entry point at which the power cord enters the cooking grill 100 is weather sealed.

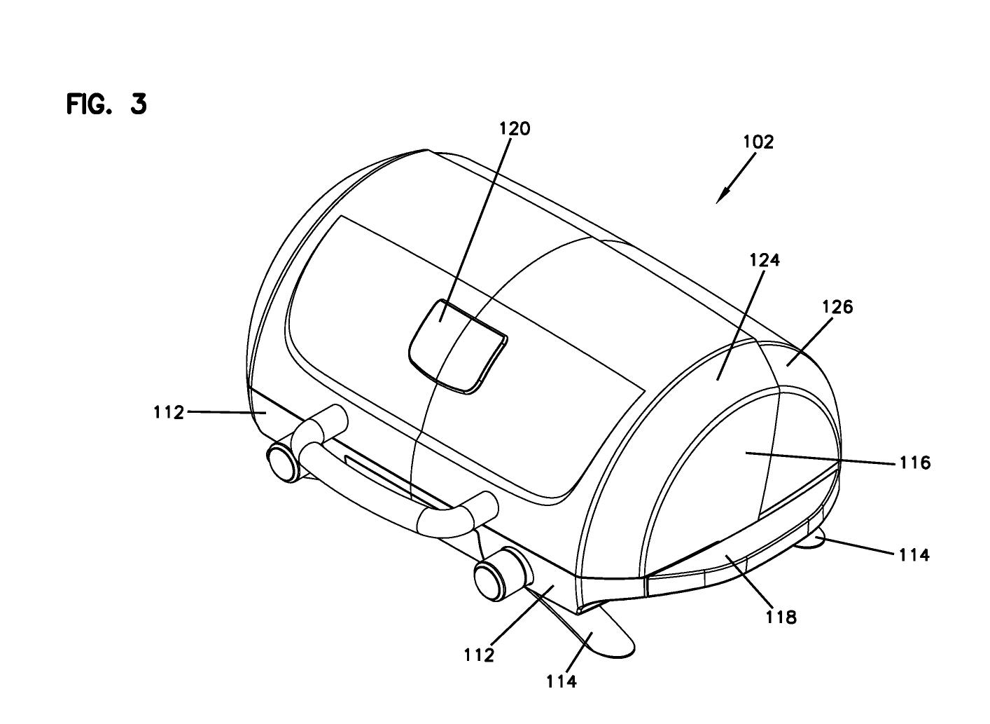

FIG. 3 shows an example of the cooking portion 102 of the cooking grill 100. The cooking portion 102 includes a housing 112, a pair of grill legs 114, and a cover 116. The cooking portion 102 is configured to operate when connected to the grill stand 104 or detached from the grill stand 104, such as when placed on a table or counter top.

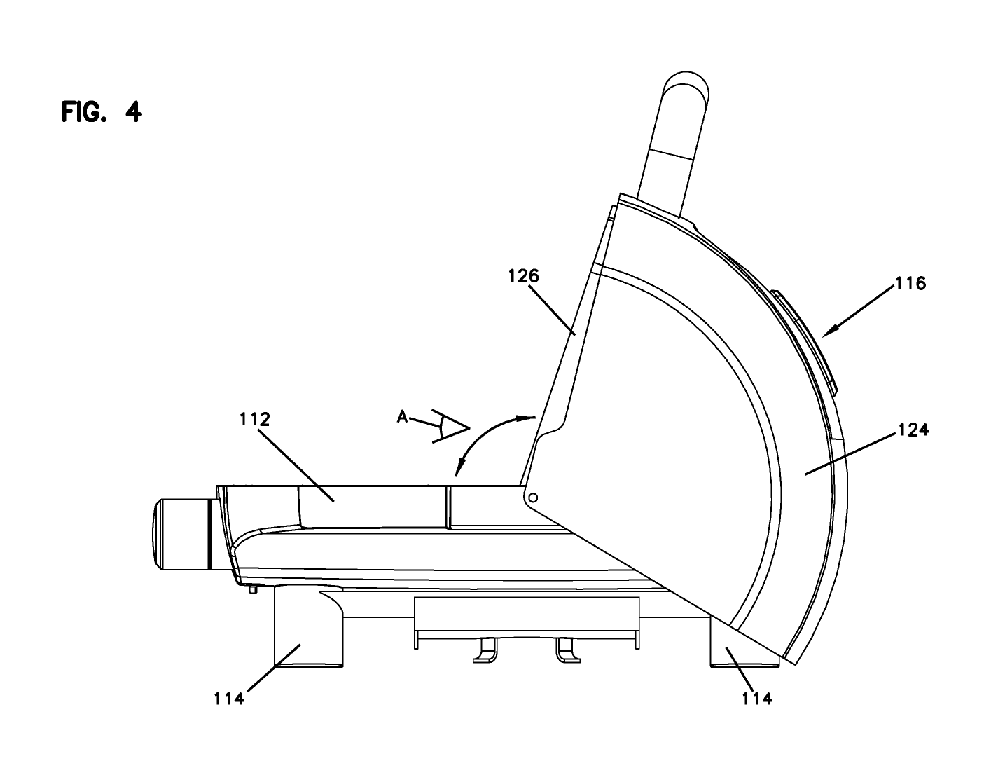

The housing 112 is configured to hold the internal components of the cooking grill 100 (shown in more detail in FIGS. 4-10). The housing 112 includes a pair of handles 118 on its sides so that the cooking portion 102 can be easily transported. In some embodiments, the handles 118 are temperature resistant so that the cooking portion 102 is movable shortly after, or during, a cooking operation. Attached to the housing 112 is the pair of grill legs 114.

The grill legs 114 are configured to be placed on a supporting surface, such as a table or counter top, and elevates the cooking portion 102 above the supporting surface when the grill stand 104 is not attached to the cooking portion 102. By elevating the cooking portion 102 above the supporting surface, air flow is increased under housing 112, helping to keep the housing 112 and the supporting surface cool. Additionally, the grill legs 114 provide stability to the cooking portion 102 when the cooking portion 102 is not attached to the grill stand 104. The grill legs 114 give the user the flexibility to use the grill on the ground, at a low height, or on an elevated supporting surface (i.e. the table top or counter top).

In some embodiments the cover 116 is a domed cover configured to accommodate large foodstuffs within the cooking portion. The cover 116 is attached to the housing 112 and is configured to provide an enclosed cooking region. In the depicted embodiment, the cover 116 includes a thermometer 120, a handle 122, a movable portion 124, and a stationary portion 126. In some embodiments, the cover 116 can be used as wind guard when using the cooking portion 102 outdoors. In other embodiments, the cover 116 is completely removable from the grill housing 112. In the depicted embodiment, the cover 116 is configured to be a convertible cover, as illustrated and described in further detail with reference to FIG. 4.

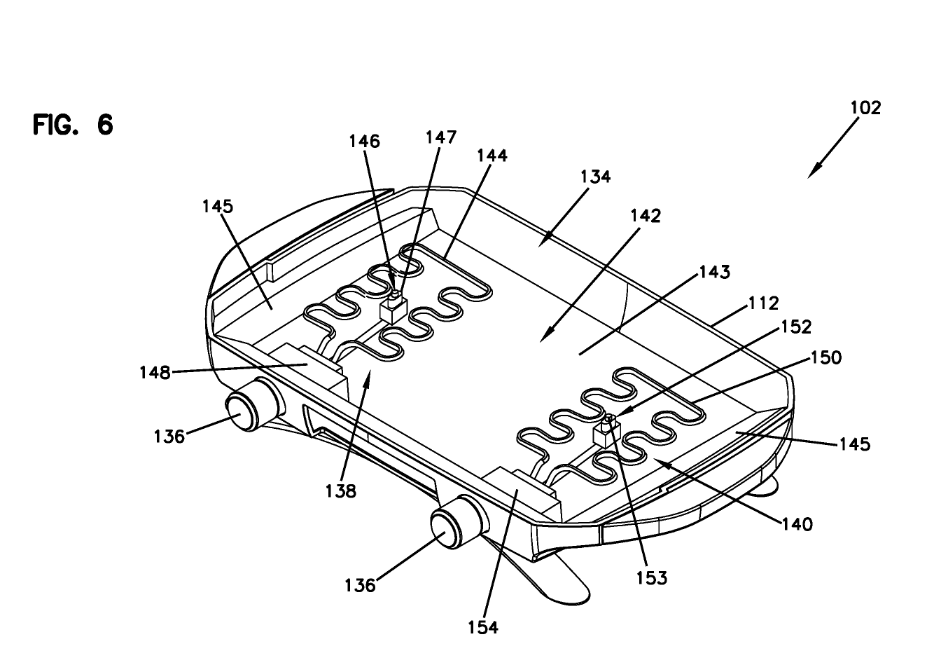

The thermometer 120 is configured to provide a temperature reading from within the inside of the cover 116. In some embodiments, the thermometer 120 is a digital thermometer. In other embodiments, the thermometer 120 is an analog thermometer. In some embodiments, the thermometer 120 is a thermostat (discussed further in connection with FIG. 6).

The handle 122 is configured to aid the user in opening the cover 116. In some embodiments, the handle 122 is temperature resistant so as to not heat up during a cooking operation.

The stationary portion 126 of the cover 116 is attached to the housing 112. While the movable portion 124 of the cover 116 is configured to be pivotable and movable with respect to the stationary portion 126. The movable portion 124 is configured to nest over of the stationary portion 126 when the cover 116 is in the open position.

FIG. 4 shows a side view of the cooking portion 102. The cover 116 is shown in the open position, with the movable portion 124 nesting over the stationary portion 126. In some embodiments, when in the open position, the cover 116 forms an angle A with the housing 112. In some embodiments, angle A is about 90 degrees. In other embodiments, angle A is about 100 degrees. In still other embodiments, angle A is in a range from about 100 degrees to about 120 degrees. In still other embodiments, the grill cover 116 is configured to expose at least 60% of the interior portion of the cooking portion 102 when in the open position.

In other embodiments, the cover 116 includes a reflective finish on the interior portion of the cover 116. In still other embodiments, the cover 116 includes a removable grate. In still other embodiments, the cover 116 includes a heating element mounted to the inside of the cover 116. In some embodiments, the heating element utilizes infrared heat.

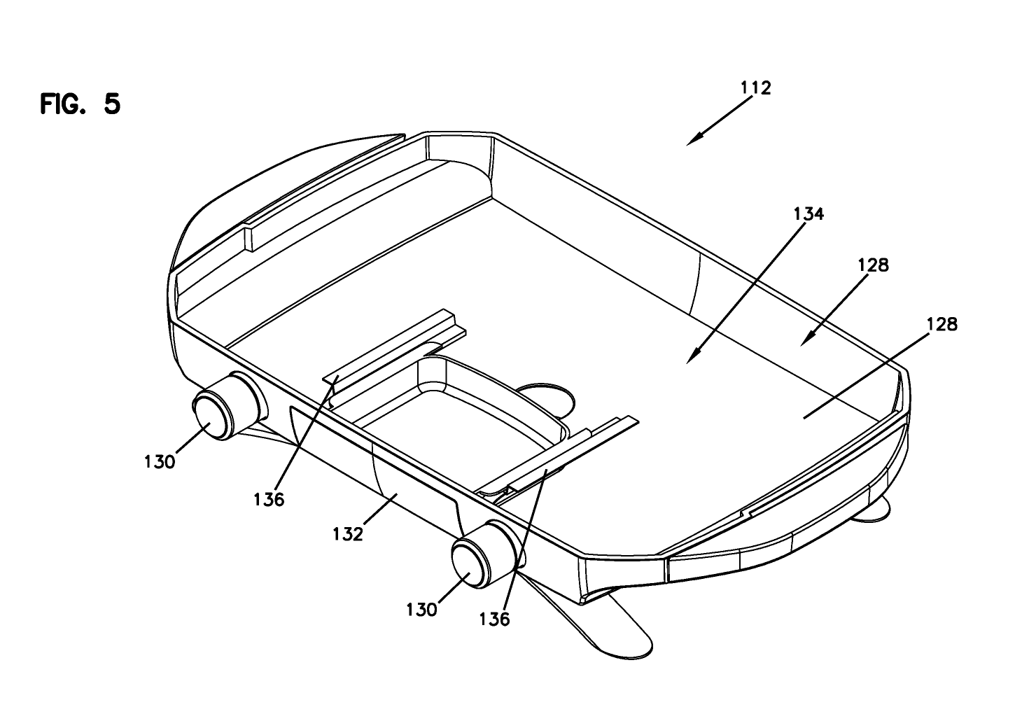

FIG. 5 shows the housing 112 of the cooking portion 102. The housing 112 includes a main body 128, a pair of control knobs 130, and a drip tray 132.

The main body 128 of the housing 112 is configured to have an internal volume 134. In some embodiments, the main body 128 is constructed of metal. In other embodiments, the main body is constructed of a heat resistant plastic. The main body can further include a substantially flat lower portion 129.

The control knobs 130 are configured to be rotatable for selectively controlling particular functions of the cooking portion 102. Specifically, the knobs 130 are configured to set the operation temperature at which the cooking portion 102 will operate when cooking a foodstuff In other embodiments, the control knobs 130 are mechanical buttons. In some embodiments, the control knobs 130 are controlling elements that utilize digital or capacitive control input. For example, the control knobs 130 are controller elements that are capacitive touch button, slider, or wheels. In still other embodiments, the control knobs 130 are controlling elements that are part of an external remote device.

The drip tray 132 is configured to collect drippings from a foodstuff during a cooking operation. By collecting drippings, clean-up of the cooking portion 102 is expedited. The drip tray 132 is configured to be removable from the housing 112. The drip tray 132 is held suspended in the interior volume 134 by a pair of drip tray rails 136. In some embodiments, the drip tray rails 136 are attached to the housing 112. In the depicted embodiment, the drip tray 132 is shown installed in the housing 112. The drip tray 132 is flush with an exterior of the housing 112 when installed, and can be slid out, or removed, along the drip tray rails 136 for cleaning and emptying. Also, in some embodiments, the drip tray 132 includes a removable handle (not shown) on the portion of the drip tray 132 that is outside of the interior volume 134 of the housing 112. In other embodiments, the cooking portion 102 can include a plurality of drip trays. In still other embodiments, the drip tray 132 can be positioned at the side of the housing 112 or at the rear of the housing 112.

FIG. 6 shows a perspective view of a select number of components of the cooking portion 102. The interior volume 134 of the housing 112 includes a first heating assembly 138, a second heating assembly 140, and a reflector pan 142.

The first heating assembly 138 includes a first heating element 144, a first thermostat 146, and a first controller 148. The second heating assembly 140 includes a second heating element 150, a second thermostat 152, and a second controller 154. The first and second heating assemblies 138, 140 are configured to selectively provide a cooking heat source. In the depicted embodiment, the first and second heating assemblies 138, 140 are substantially similar and will be described together herein.

The heating elements 144, 150 are configured to provide a heating source for the cooking portion 102 of the cooking grill 100. The heating elements 144, 150 are configured to be provided electrical power from a source of electricity, preferably provided by the power cord 106 (shown in FIG. 1). In some embodiments, the heating elements 144, 150 are operable by way of a DC power source (i.e. a battery). In the depicted embodiment, the heating elements 144, 150 are tubular heating elements configured to produce radiant heat. The heating elements 144, 150 are coiled within the interior volume 134 of the housing 112. In some embodiments, the heating elements 144, 150 also each include a flat interfacing plate. In other embodiments, the heating elements 144, 150 are each a quartz infrared heating element. In other embodiments still, the heating elements 144, 150 are each an infrared halogen heating element. In still other embodiments, the heating elements 144, 150 are each a thin-film heating element, such as a polymer thick film heating element.

The thermostats 146, 152 are configured to provide a temperature reading. In some embodiments, thermostats 146, 152 are configured to be provided electrical power from a source of electricity, preferably provided by the power cord 106 (shown in FIG. 1). In the depicted embodiment, thermostats 146, 152 are spring-loaded thermostats that include contact surfaces 147, 153, respectively. The contact surfaces 147, 153 are configured to be depressed when a plate is properly installed and to maintain a pressure contact between the thermostats 146, 152 and the plates to allow the thermostats 146, 152 to measure the temperatures of the plates arranged thereon.

The controllers 148, 154 are schematically shown in FIG. 6. The controllers 148, 154 are configured to control the behavior of the heating elements 144, 150.. The controllers 148, 154 are in communication with the heating elements 144, 150 and the thermostats 146, 152. The controllers 148, 154 each receive an input from the control knobs 130. In some embodiments, the input provided by each control knob 130 is a desired temperature setting. The controllers 148, 154 receive the signal from the control knobs 130 and output a signal to the heating elements 144, 150 based on the control knobs 130 input. During a cooking operation, the controllers 148, 154 are also configured to each receive an input from the thermostats 146, 152 respectively. The inputs provided by the thermostats 146, 152 are representative of a temperature of a surface with which each thermostat is in communication. In some embodiments, both thermostats 146, 152 are in communication with the same surface. In other embodiments, the thermostats 146, 152 are each in communication with different surfaces. If the input from the thermostats 146, 152 differs from the input provided by the control knobs 130, the controllers 148, 154 alter the behavior of the heating elements 144, 150 they are in communication with accordingly.

In one possible configuration, and by non-limiting example, if the control knob is set to a heat of 300 degrees Fahrenheit, but the first thermostat 146 returns a temperature value of 325 degrees Fahrenheit, the first controller 148 turns the first heating element 144 off until the first thermostat 146 reading is about 300 degrees Fahrenheit, at which time, the first heating element 144 is turned back on. This process can repeat several times during a cooking operation, resulting in the first controller 148 turning the first heating element 144 off and on multiple times to maintain a set temperature dictated by the control knob 130.

In other embodiments, the controllers 148, 154 are in communication with the thermostat 120 located in the cover 116 of the cooking portion 102. In such an embodiment, the controllers 148, 154 are configured to each receive an input from the thermostat 120 in the cover 116. The input provided by the thermostat 120 is representative of a temperature of the interior environment of the cooking portion 102 with which thermostat 120 is in communication. If the input from the thermostat 120 differs from the input provided by the control knobs 130, the controllers 148, 154 alter the behavior of the heating elements 144, 150 they are in communication with accordingly.

In some embodiments, the controllers 148, 154 will not turn on the heating elements 144, 150 unless the contact surfaces 147, 153 of the thermostats 146, 152 are depressed, regardless of the positions of the control knobs. This can be a safety feature that prevents the heating elements 144, 150 from being exposed when hot.

The controllers 148, 154 may be configured for analog operation, digital operation, or a combination of analog and digital operation. For example, the controllers 148, 154 may be configured such that the heating element 144, thermostat 146 and control knob 130 are electric components that are connected together, along with other components, for analog thermostatic control in which the output of the heating element 144 is solely a function of the control knob setting 130. Alternatively, the controllers 148, 154 can be provided with an electronic processor and memory such that the output to the heating element 144, 150 is further controllable via software. In one example, the controllers 148, 154 are provided with a wireless communication device, such as a Wi-Fi chip, to allow a user to remotely control the cooking portion 102. In one example, the wireless communication device, allows a user to enable and disable the operation of the first and second heating assemblies 138, 140 remotely. In a second example, the wireless communication device is also used to send status or sensor data from the cooking portion 102 to permit remotely monitoring of the cooking portion. The wireless communication device can communicate directly with another computing device, such as a smartphone, or through a data communication network, such as a cellular network, the Internet, or a local area network. In one example, the communication device includes a Wi-Fi chipset includes an on-chip processor and memory such that an additional system level controller is not needed in the controllers 148, 154.

The reflector pan 142 is configured to be contained within the interior volume 134 of the housing 112. The reflector pan is positioned under the first and second heating assemblies 138, 140, but above a lower portion 129 (shown in FIG. 5) of the body 128 of the housing 112. The reflector pan 142 is configured to be shallow and has a substantially flat bottom segment 143 and oblique side segments 145 such that heat radiated downward or sideways from the heating elements 144, 150 is reflected upward. This facilitates optimal use of the heat created by the first and second heating assemblies 138, 140.

The first and second heating assemblies 138, 140 are configured so that a user may alter the behavior of each individual heating element 144, 150 individually to offer a customized heating environment. While two heating assemblies 138, 140 are shown, the cooking portion 102 can include a plurality of heating assemblies. For example, the cooking portion 102 can include three heating assemblies (each assembly including a controller, a thermostat, and a heating element). In another example, the cooking portion 102 includes four heating assemblies (each assembly including a controller, a thermostat, and a heating element). In other examples, the cooking portion 102 includes a single heating assembly. In other embodiments, the heating elements 144, 150, the thermostats 146, 152, the controllers 148, 154, and/or the reflector pan 142, may be suitably configured to optimize heating in the cooking portion 102 (e.g., the reflector pan 142 may be contoured in another manner, or the heating elements 144, 150 may be positioned in another location or shaped differently). In some embodiments, the reflector pan 142 is installed over the drip tray 132 (shown in FIG. 5). In other embodiments, the drip tray 132 is installed over the reflector pan 142. The drip tray 132 is not shown in FIG. 6.

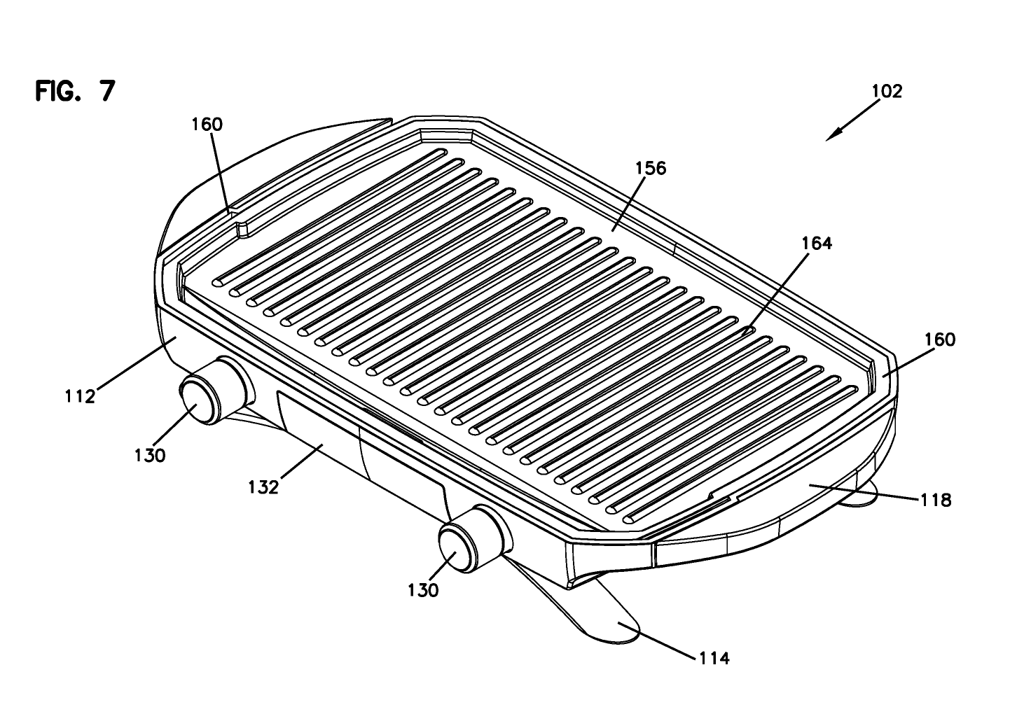

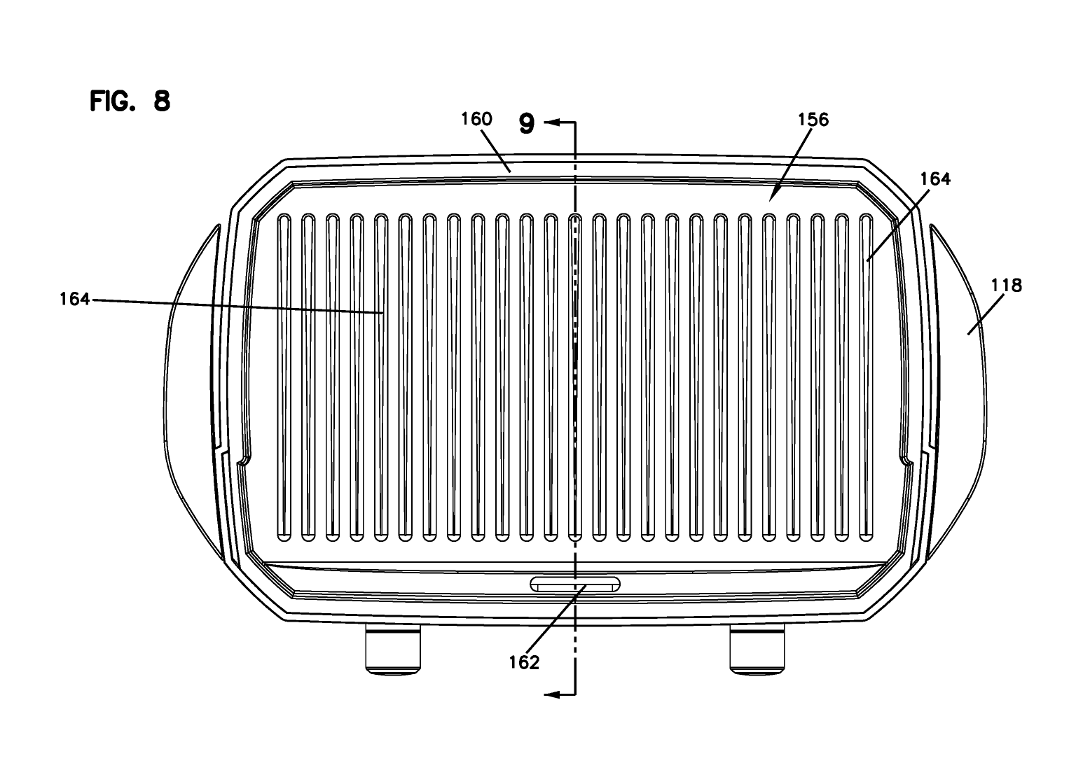

FIGS. 7-8 show the cooking portion 102 with a grill plate 156. The cooking portion 102 is shown without the cover 116 for illustration purposes. The grill plate is configured to heat and hold a foodstuff for cooking. The grill plate 156 includes a cooking surface 158, a supporting lip 160, and a drain hole 162. The grill plate 156 is configured to receive and retain heat created by the first and second heating assemblies 138, 140.

The cooking surface 158 of the grill plate 156 is configured to be a non-porous surface. By having a nonporous surface, the grill plate 156 contains all pieces of foodstuffs, and all fluids from the foodstuffs, to the grill plate 156, away from the heating elements 144, 150. This prevents any fumes, or smoke, usually caused when foodstuffs or foodstuff drippings come into contact with a hot heating element. Additionally, due to the nonporous feature of the grill plate 156, the cooking portion 102 is suitable for indoor use as well as outdoor use, as there is no risk of fumes, smoke, or open flames. Further, foodstuffs having varying consistencies can also be cooked on the grill plate without the risk of falling through the grill plate 156. For example, eggs, stir fry, small vegetables, beans, etc. can be cooked on the cooking surface 158.

The cooking surface 158 can also be configured to include a plurality of different cooking features 164. In the depicted embodiment, the cooking surface 158 includes cooking features 164 that are raised ribs. The raised ribs are configured to raise a foodstuff from a flat portion of the grill plate 156. In some embodiments, the grill plate 156 includes corresponding recesses in the underside of the grill plate when the cooking surface 158 includes ribs so that heat is apportioned evenly across the cooking surface 158. The cooking surface is customizable to optimally cook a variety of different foodstuffs. For illustration, and by non-limiting example, the cooking surface 158 can be a waffle griddle, a flat griddle, a baking dish with raised sides, an omelet tray, a concave wok, etc. In some embodiments, the cooking surface 158 is configured to receive an insert that is configured for optimally cooking particular foodstuffs. For illustration, and by non-limiting example, the inserts can include a meat slider insert, a meatball insert, a muffin insert, etc. By providing a removable grill plate 156, the user can exchange multiple plates during a single sitting, allowing the user to optimally cook a variety of foodstuffs.

The grill plate 156 is configured to be removably seated on the housing 112. In some embodiments, the grill plate 156 includes the supporting lip 160 disposed at the edges of the grill plate 156. In some embodiments, the supporting lip 160 is configured to be seated within the housing 112 so that the grill plate 156 is flush with the handles 118. In some embodiments, the supporting lip 160 is configured to be seated on top of the housing 112. In some embodiments, the grill plate 156 nests within the handles 118. In some embodiments, the grill plate 156 includes tabs that are nested within the handles 118. In other embodiments, the grill plate 156 is configured to have grill plate handles. In such an embodiment, the grill plate handles are configured to nest within recessed portions of the handles 118 of the housing 112 when the grill plate 156 is seated in the cooking portion 102. In some embodiments, the grill plate handles are temperature resistant in order to allow the grill plate 156 to be easily transported when the cooking surface 158 is still warm. Additionally, foodstuffs can be transported directly on the grill plate 156 as the user can hold the grill plate handles to transport the grill plate 156. When seated, the grill plate is configured to be in communication with at least one of the first or second thermostats 146, 152 (shown in FIG. 6). In some embodiments, the grill plate 156 depresses the contact surfaces 147, 153 of at least one of the first or second thermostats 146, 152

As shown in FIG. 8, the drain hole 162 is positioned at the front of the grill plate 156. The drain hole 162 provides access to the drip tray 132. By providing a drain hole 162 that provides access to the drip tray 132, all fluids that run off the grill plate 156 are contained in the removable drip tray 132, improving the ease of cleaning of the cooking portion 102 after a cooking operation.

By making the grill plate 156 removable, the user can freely clean the grill plate at a location away from the cooking portion 102. For example, the user can remove the grill plate 156 and wash the grill plate 156 in a sink or place the grill plate 156 in a dishwasher for hands-free cleaning.

The grill plate 156 can be constructed from a variety of materials. Exemplary materials include die cast aluminum, cast iron, and stainless steel. Other materials or combinations of materials are used in other embodiments. Additionally, in some embodiments the grill plate has one or more of a variety of dishwasher safe coatings applied to the cooking surface 158 including a variety of different, easy cleaning nonstick coatings (e.g. PTFE, ceramic, silicone, etc.).

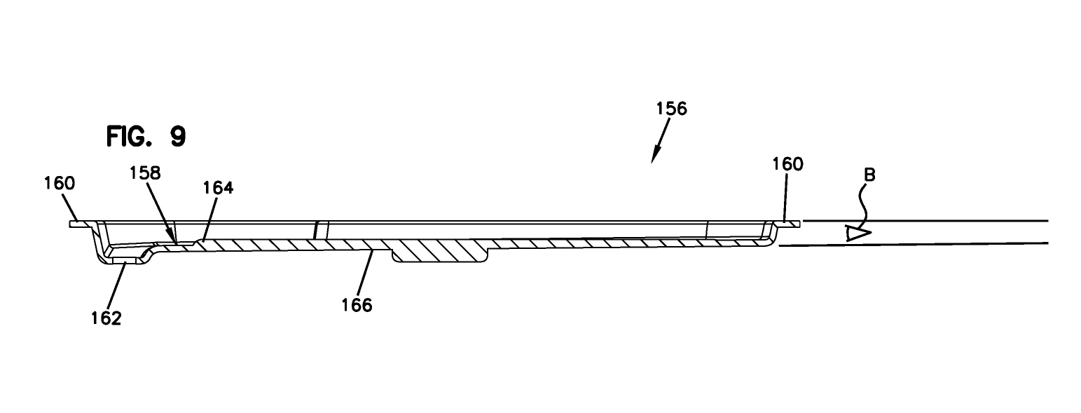

FIG. 9 depicts a cross-section of the grill plate 156 along line 9-9 in FIG. 8. In the depicted embodiment, the cooking surface 158 includes a slope angled toward the drain hole 162. In this example, the cooking surface 158 forms an angle B with the horizontal plane. In some embodiments, the angle B is in a range from about 5 degrees to about 15 degrees, and preferably about 8 degrees. In some embodiments, the cooking surface 158 is sloped at an angle B such that up to about 42% of the fat is removed from 80/20 ground chuck burgers after being cooked on the grill plate 156. Once heated, the fat liquefies and is collected on the cooking surface 158, where the slope of the cooking surface directs it through the drain hole 162 and into the drip trays 132. In some embodiments, the cooking surface 158 forms no angle with the horizontal plane in a resting state. However, in such an embodiment, the housing 112 of which the grill plate 156 is seated upon is tiltable so that the cooking surface 158 is sloped toward the front of the cooking portion 152.

The grill plate 156 also includes a receiving portion 166 positioned on the underside of the grill plate 156. The receiving portion 166 is configured to interface with the first heating element 144, second heating element 150, or both. Additionally, the receiving portion 166 is configured to come in contact with the first thermostat 146, the second thermostat 152 or both. In some embodiments, the receiving portion 166 is a flat surface. In other embodiments, the receiving portion 166 is a channel sized to receive the heating elements 144, 150.

In other embodiments, the grill plate 156 can include a fluid channel disposed around the outer edges of the grill plate 156. The fluid channel is configured to direct fluid from the cooking surface 158 to drainage locations on the grill plate 156 (i.e. the drain hole 162).

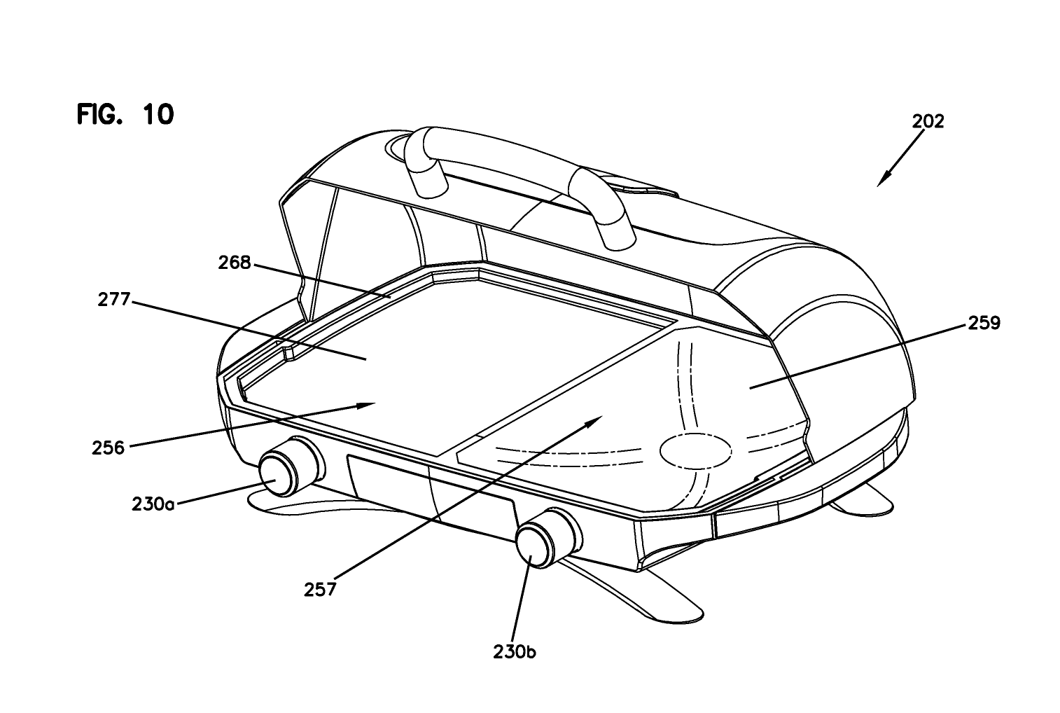

FIG. 10 shows a cooking portion 202 according to one embodiment of the present disclosure. The cooking portion 202 includes substantially the same internal features as the cooking portion 102 described above. As depicted, the cooking portion 202 includes a first grill plate 256, and a second grill plate 257. The first and second grill plates 256, 257 are removable.

By using more than one grill plate, the user is offered the freedom to optimally cook a variety of foodstuffs using grill plates 256, 257, that have cooking surfaces that include the same or different cooking features. The grill plates 256, 257 including many of the same aspects as the grill plate 156 mentioned above.

The first grill plate 256 is configured to be positioned over a first heating assembly (such as heating assembly 138 shown in FIG. 6). The second grill plate 257 is positioned over a second heating assembly (such as the heating assembly 140 shown in FIG. 6). Accordingly, the first and second heating arrangements can be operated by a user using the control knobs 230a, 230b, respectively.

In the depicted embodiment, the first grill plate 256 has a cooking surface 258 that has cooking features that include a plurality of side walls 268 that surround the cooking surface 258. The side walls 268 are positioned so that the cooking surface 258 is lower than the top of the side walls 268.

In the depicted embodiment, the second grill plate 257 has a cooking surface 259 that is concave. The concave cooking surface 259 provides a bowl-like cooking surface resembling a wok.

Described above is a single grill plate 156 configuration and a two grill plate 256, 257 configuration for the cooking portions 102, 202. However, it is contemplated that a plurality of grill plates (e.g., two, three, four, five, six, or more) having the same, or different, cooking surface structures may be used in a cooking portion. The grill plates may be suitably configured within the grilling portion to optimize heating and cooking in the cooking portion.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A cooking grill comprising:
a housing containing a first heating element and a second heating element;
a grill plate removably mountable on the housing, the grill plate having a top surface and a bottom surface, wherein the top surface is a cooking surface;
a grill cover configured to cover the removable grill plate and define a cooking region between the grill plate top surface and the grill cover;
a removable stand configured for attachment to the grill housing, the removable stand being configured to support the cooking grill on a ground surface at a table height; and
a power supply within the housing configured to be electrically connected to an external power source and configured to supply power to the first and second heating elements.

2. The cooking grill of claim 1, further comprising at least one drip pan removably mounted flush with the housing and under the grill plate, the drip pan being configured to collect liquid from the grill plate.

3-4. (canceled)

5. The cooking grill of claim 1, wherein the top surface of the grill plate has a flat surface.

6. The cooking grill of claim 1, wherein top surface of the grill plate has a plurality of raised ribs.

7. The cooking grill of claim 1, wherein the grill plate has a concave top surface.

8. The cooking grill of claim 1, wherein the grill plate has a plurality of side walls surrounding the grill plate, and wherein the top surface is positioned lower than the top of the side walls.

9. The cooking grill of claim 1, further comprising a thermostat in contact with the grill plate.

10. The cooking grill of claim 9, further comprising a controller in communication with the first and second heating elements and the thermostat, and wherein the controller is configured alter the behavior of the first and second heating elements based on measurements taken by the thermostat.

11. The cooking grill of claim 1, further comprising a pair of integral support legs attached to the housing, the support legs being configured to support the cooking grill at a height shorter than a height of the removable stand.

12. The cooking grill of claim 1, wherein the grill cover includes a heat reflective material mounted to an interior surface of the grill cover.

13. The cooking grill of claim 1, wherein the grill plate nests in a top surface of the housing.

14. The cooking grill of claim 1, wherein the top surface of the grill plate has a slope in a range from about 5 degrees to about 15 degrees.

15. The cooking grill of claim 1, wherein the cooking grill is tiltable so that the grill plate has a slope in a range from about 5 degrees to about 15 degrees.

16. (canceled)

17. The cooking grill of claim 1, further comprising a second grill plate removably mounted to the housing, the second grill plate having a top surface and a bottom surface, wherein the top surface is a cooking surface and the bottom surface includes a receiving portion to receive the second heating element, and wherein the bottom surface of the first grill plate includes a receiving portion to receive the first heating element.

18-22. (canceled)

23. The cooking grill of claim 1, wherein the grill cover is hinged and configured to uncover at least 60% of the top surface of the grill plates.

24. The cooking grill of claim 23, wherein the grill cover is includes a fixed portion secured to the housing of the cooking grill and a movable portion pivotable about the fixed portion, wherein in the movable portion is configured to nest over of the stationary portion when the cover is in an open position.

25. A cooking grill comprising:
a housing containing at a first heating element and a second heating element;
a first grill plate removably mountable to the housing, the first grill plate having a top surface and a bottom surface, wherein the top surface is a cooking surface and the bottom surface includes a receiving portion to receive the first heating element;
a second grill plate removably mountable to the housing, the second grill plate having a top surface and a bottom surface, wherein the top surface is a cooking surface and the bottom surface includes a receiving portion to receive the second heating element;
at least one drip tray removably mounted flush with the housing and under the first and second grill plates, the drip tray being configured to collect liquid from the first and second grill plate;
a first thermostat in communication with the first grill plate;
a second thermostat in communication with the second grill plate;
a controller in communication with the first and second heating elements and the first and second thermostats, wherein the controller is configured to alter the behavior of the first and second heating elements based on measurements taken by the first and second thermostats;
a grill cover configured to cover the first and second grill plates; and
a power supply contained in the housing and configured to be electrically connected to an external power source, the external power source be configured to power the first and second heating elements and the first and second thermostats.

26-30. (canceled)

31. The cooking grill of claim 25, wherein at least one of the first or second grill plates includes a sloped top surface, the slope being in a direction of the position of drip tray.

32. (canceled)

33. The cooking grill of claim 25, wherein the top surfaces of the first and second grill plates each include a cooking feature, and wherein the cooking feature of the first and second grill plates are different.

34. The cooking grill of claim 25, further comprising a removable stand configured to be attached to the grill housing, the removable stand being configured to support the cooking grill at a table height from a ground surface.

35. (canceled)
